(19) United States
(12) Patent Application Publication
(10) Pub. No.: US 2013/0071758 A1
(43) Pub. Date: Mar. 21, 2013

(54) NONAQUEOUS ELECTROLYTE FOR ELECTROCHEMICAL DEVICE, AND ELECTROCHEMICAL DEVICE

(71) Applicants: Masayuki OYA, Kyoto (JP); Mitsuhiro KISHIMI, Kyoto (JP); Fusaji KITA, Kyoto (JP)

(72) Inventors: Masayuki OYA, Kyoto (JP); Mitsuhiro KISHIMI, Kyoto (JP); Fusaji KITA, Kyoto (JP)

(73) Assignee: HITACHI MAXELL ENERGY, LTD., Kyoto (JP)

(21) Appl. No.: 13/614,680

(22) Filed: Sep. 13, 2012

(30) Foreign Application Priority Data
Sep. 14, 2011 (JP) 2011-200391

(51) Int. Cl. H01M 10/0566

(52) U.S. Cl. CPC H01M 10/0566
USPC 429/328; 429/330; 429/331

(57) ABSTRACT

The nonaqueous electrolyte for an electrochemical device of the present invention includes at least one selected from an imide compound represented by the general formula (1) and an imide compound represented by the general formula (2):

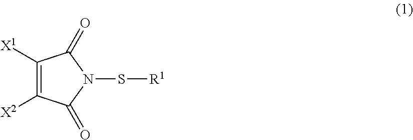

where R¹ is an organic residue or an F-containing organic residue, X¹ and X² are each H, F, an organic residue or an F-containing organic residue, and X¹ and X² may be the same or different from each other; and

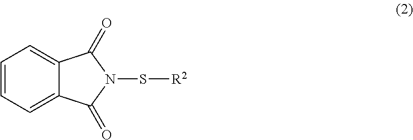

where R² is an organic residue or an F-containing organic residue, and H of a benzene ring may be partially or entirely replaced with F.

### BACKGROUND OF THE INVENTION

1. Field of the Invention

The present invention relates to a nonaqueous electrolyte with which an electrochemical device with excellent high-temperature storability can be formed, and an electrochemical device using the nonaqueous electrolyte.

2. Description of Related Art

With the development of portable electronic devices such as portable phones and notebook personal computers and the commercialization of electric vehicles, demands for electrochemical devices, such as nonaqueous secondary batteries having a high energy density, have been increasing rapidly in recent years. Currently, to form nonaqueous secondary batteries that can respond to such demands, a positive electrode using a lithium composite oxide capable of doping and de-doping lithium ions, a negative electrode using lithium metal or a material capable of doping and de-doping lithium ions, and a nonaqueous electrolyte obtained by dissolving electrolyte salt in an organic solvent are used, for example.

When being stored under high temperature conditions, nonaqueous secondary batteries may present problems such as swelling caused by the evolution of gas resulting from various reactions between the nonaqueous electrolyte and the positive electrode active material. Lithium composite oxides used as positive electrode active materials for nonaqueous secondary batteries, such as LiCoO₂, LiNiO₂, LiMnO₂ and LiMn_{1.5}Ni_{0.5}O₄, serve as a kind of catalyst. Thus, under high temperature conditions, lithium composite oxides react with the nonaqueous electrolyte and produces gas, and this gas causes battery swelling and a decline in battery capacity. In particular, nickel-containing lithium composite oxides, the materials receiving attention in recent years due to their larger capacity and the reserve of the elements, have a larger catalytic action than that of LiCoO₂, which has been commonly used up until now. Further, at the time of synthesis of nickel-containing lithium composite oxides, alkaline components remain in the oxides, and they facilitate the evolution of gas. Therefore, it is an urgent necessity to develop the means for solving these problems.

For nonaqueous secondary batteries, various studies have been conducted on additives, inclusion of small amount of which in a nonaqueous electrolyte or electrode leads to an improvement in battery characteristics. For example, Japanese Patent Nos. 3,369,947 and 3,416,016, and JP 2000-182621 A propose to use a negative electrode and a nonaqueous electrolyte containing certain imide compound additives to form a battery in order to suppress reactions between a nonaqueous electrolyte solvent and a negative electrode active material.

In this way, reactions between the negative electrode active material and the nonaqueous electrolyte solvent can be suppressed to a certain extent by adding certain imide compounds to the negative electrode and to the nonaqueous electrolyte. However, by these techniques, reactions between a positive electrode active material and a nonaqueous electrolyte cannot be suppressed adequately.

Further, when using high-capacity positive electrode active materials such as nickel-containing lithium composite oxides, the capacity of the negative electrode needs to be increased accordingly. However, depending on the type of negative electrode active material used, reactions between the negative electrode active material and the nonaqueous electrolyte solvent may need to be newly suppressed.

With the foregoing in mind, the present invention provides a nonaqueous electrolyte with which an electrochemical device with excellent high-temperature storability can be formed, and an electrochemical device using the nonaqueous electrolyte.

### SUMMARY OF THE INVENTION

The nonaqueous electrolyte for an electrochemical device of the present invention includes at least one selected from an imide compound represented by the general formula (1) and an imide compound represented by the general formula (2):

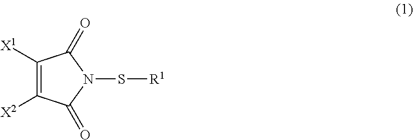

where R¹ is an organic residue or an F-containing organic residue, X¹ and X² are each H, F, an organic residue or an F-containing organic residue, and X¹ and X² may be the same or different from each other; and

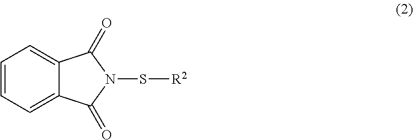

where R² is an organic residue or an F-containing organic residue, and H of a benzene ring may be partially or entirely replaced with F.

Further, the electrochemical device of the present invention includes a positive electrode, a negative electrode, a separator, and the nonaqueous electrolyte for an electrochemical device of the present invention.

According to the present invention, the nonaqueous electrolyte including the additive that can favorably suppress reactions between an active material and an electrolyte solvent is used. Thus, it is possible to provide an electrochemical device with excellent high-temperature storability.

### BRIEF DESCRIPTION OF THE DRAWINGS

FIG. 1A is a plan view showing an exemplary nonaqueous secondary battery according to the present invention, and FIG. 1B is a cross-sectional view of the battery shown in FIG. 1A.

FIG. 2 is a perspective view of the nonaqueous secondary battery shown in FIGS. 1A and 1B.

FIG. 3 is a plan view showing other exemplary nonaqueous secondary battery according to the present invention.

### DETAILED DESCRIPTION OF THE INVENTION

(Nonaqueous Electrolyte for Electrochemical Device)

First, the nonaqueous electrolyte for an electrochemical device (hereinafter may be simply referred to as the “electrolyte”) of the present invention will be explained.

The nonaqueous electrolyte for an electrochemical device of the present invention is a solution obtained by dissolving electrolyte salt in an organic solvent and includes at least one selected from an imide compound represented by the general formula (1) and an imide compound represented by the general formula (2).

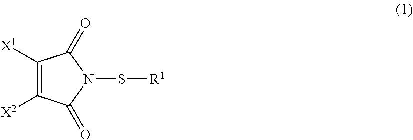

Where R¹ is an organic residue or an F-containing organic residue, X¹ and X² are each H, F, an organic residue or an F-containing organic residue, and X¹ and X² may be the same or different from each other.

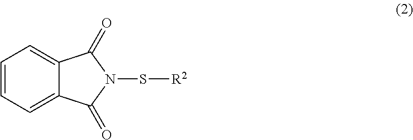

Where R² is an organic residue or an F-containing organic residue, and H of a benzene ring may be partially or entirely replaced with F.

In an electrochemical device using the electrolyte of the present invention as a component (i.e., the electrochemical device of the present invention (described later)), it is believed that reactions between a positive electrode active material and the nonaqueous electrolyte are suppressed favorably by the action of the imide compound represented by the general formula (1) and/or the imide compound represented by the general formula (2).

On the other hand, it is believed that fluorinated cyclic carbonate (described later) can favorably deliver its effect of suppressing reactions between a negative electrode active material and the nonaqueous electrolyte because the imide compound represented by the general formula (1) and/or the imide compound represented by the general formula (2) is added to the electrolyte. Thus, even if the electrochemical device is stored under high temperature conditions, these actions prevent the evolution of gas in the electrochemical device, thereby preventing, for example, swelling of the electrochemical device. For this reason, the electrochemical device using the electrolyte of the present invention as a component has improved high-temperature storability.

In the imide compound represented by the general formula (1), R¹ is an organic residue or an F-containing organic residue (H of an organic residue is partially or entirely replaced with F). The organic residue or the F-containing organic residue preferably has a carbon number of 1 to 10. Straight chain, branched, or cyclic alkyl groups (including those with H being partially or entirely replaced with F) and phenyl groups (including those with H being partially or entirely replaced with F) having the above carbon number are more preferable, and phenyl groups or cyclic alkyl groups having a carbon number of 5 to 6 are particularly preferable as the organic residue or the F-containing organic residue.

Further, in the imide compound represented by the general formula (1), X¹ and X² are each H, F, an organic residue or an F-containing organic residue. However, it is preferable that X¹ and X² are each H, F or an alkyl group having a carbon number of 1 to 3 (including those with H being partially or entirely replaced with F).

Furthermore, in the imide compound represented by the general formula (2), R² is an organic residue or an F-containing organic residue (H of an organic residue is partially or entirely replaced with F). The organic residue or the F-containing organic residue preferably has a carbon number of 1 to 10. Straight chain, branched, or cyclic alkyl groups (including those with H being partially or entirely replaced with F) and phenyl groups (including those with H being partially or entirely replaced with F) having the above carbon number are more preferable, and phenyl groups or cyclic alkyl groups having a carbon number of 5 to 6 are particularly preferable as the organic residue or the F-containing organic residue.

Although the electrolyte of the present invention needs to at least include one of the imide compound represented by the general formula (1) and the imide compound represented by the general formula (2), it may contain both of the imide compounds. When the electrolyte of the present invention includes the imide compound represented by the general formula (1), the electrolyte needs to at least contain one kind of the imide compound represented by the general formula (1). It is to be noted, however, that the electrolyte may include more than one kind of the imide compound represented by the general formula (1). Further, when the electrolyte of the present invention includes the imide compound represented by the general formula (2), the electrolyte needs to at least contain one kind of the imide compound represented by the general formula (2). It is to be noted, however, that the electrolyte may include more than one kind of the imide compound represented by the general formula (2).

The amount of the imide compound represented by the general formula (1) and that of the imide compound represented by the general formula (2) in the electrolyte of the present invention [when the electrolyte includes only one kind of the imide compound, the amount refers to the amount of the imide compound contained but when the electrolyte includes more than one kind of the imide compound, the amount refers to the total amount of the imide compounds contained; the same is true for the amount of the imide compound represented by the general formula (1) and that of the imide compound represented by the general formula (2)] is preferably 0.05 mass % or more, and more preferably 0.2 mass % or more of the total amount of the electrolyte in terms of ensuring the effects resulting from the use of the imide compounds (i.e., the effects of improving the high-temperature storability of the electrochemical device).

The imide compound represented by the general formula (1) and the imide compound represented by the general formula (2) form a coating on the surface of the positive electrode in the electrochemical device. If the amount of the compound(s) contained in the electrolyte is too large, the coating becomes too thick and this may adversely affect, for example, the load characteristics of the electrochemical device. Therefore, the amount of the imide compound represented by the general formula (1) and that of the imide compound represented by the general formula (2) in the electrolyte of the present invention are preferably 3 mass % or less, and more preferably 1 mass % or less.

It is preferable that the electrolyte of the present invention further includes fluorinated cyclic carbonate. It is believed that the inclusion of the fluorinated cyclic carbonate in the electrolyte allows the formation of a coating on the surface of the negative electrode, so that reactions between a negative electrode active material and the nonaqueous electrolyte can be suppressed favorbaly.

For the fluorinated cyclic carbonate, it is possible to use compounds obtained by partially or entirely replacing H of cyclic carbonates, such as ethylene carbonate, propylene carbonate, and butylene carbonate, with F. In particular, fluoroethylene carbonate (FEC) can be used preferably.

The addition of the fluorinated cyclic carbonate to the electrolyte may cause swelling of the electrochemical device inside the electrochemical device. However, since the electrolyte of the present invention contains the imide compound represented by the general formula (1) and/or the imide compound represented by the general formula (2), the action of these imide compounds enables to exploit the functions of the fluorinated cyclic carbonate effectively while suppressing the problems associated with the fluorinated cyclic carbonate.

The amount of the fluorinated cyclic carbonate added to the electrolyte is preferably 0.1 mass % or more of the total amount of the electrolyte in order to achieve the effect of suppressing reactions between the electrolyte and a negative electrode active material to a certain extent. On the other hand, in order to prevent the deterioration of, for example, the load characteristics, the amount of the fluorinated cyclic carbonate added to the electrolyte is preferably 5 mass % or less.

For the electrolyte of the present invention, organic solvents having a high dielectric constant can be used preferably, and esters (including carbonates) are more preferable. In particular, use of esters having a dielectric constant of 30 or more is recommended. Examples of esters having such a high dielectric constant include ethylene carbonate, propylene carbonate, butylene carbonate, γ-butyrolactone, and sulfur esters (e.g., ethylene glycol sulfite). Among these, cyclic esters are preferable, and cyclic carbonates such as ethylene carbonate, propylene carbonate, and butylene carbonate are particularly preferable.

In addition to the organic solvents mentioned above, low-viscose polar organic solvents typified by dimethyl carbonate, diethyl carbonate, and methyl ethyl carbonate can also be used for the electrolyte.

Furthermore, organic solvents such as chain alkyl esters such as methyl propionate, chain phosphate triesters such as trimethyl phosphate; and nitrile solvents such as 3-methoxy propionitrile can also be used for the electrolyte.

Further, fluorine-based organic solvents can also be used for the electrolyte. Examples of fluorine-based solvents include H(CF₂)₂OCH₃, C₄F₉OCH₃, H(CF₂)₂OCH₂CH₃, H(CF₂)₂OCH₂CF₃, and H(CF₂)₂CH₂O(CF₂)₂H. Further, examples of fluorine-based solvents also include (perfluoroalkyl) alkyl esters having a straight chain structure such as CF₃CHFCF₂OCH₃, and CF₃CHFCF₂OCH₂CH₃, and iso(perfluoroalkyl)alkyl esters, namely, 2-trifluoromethyl hexafluoropropyl methyl ether, 2-trifluoromethyl hexafluoropropyl ethyl ether, 2-trifluoromethyl hexafluoropropyl propyl ether, 3-trifluorooctafluorobutyl methyl ether, 3-trifluoro octafluorobutyl ethyl ether, 3-trifluoro octafluorobutyl propyl ether, 4-trifluorodecafluoropenthyl methyl ether, 4-trifluorodecafluoropenthyl ethyl ether, 4-trifluorodecafluoropenthyl propyl ether, 5-trifluorododecafluorohexyl methyl ether, 5-trifluorododecafluorohexyl ethyl ether, 5-trifluorododecafluorohexyl propyl ether, 6-trifluorotetradecafluorohepthyl methyl ether, 6-trifluorotetradecafluorohepthyl ethyl ether, 6-trifluorotetradecafluorohepthyl propyl ether, 7-trifluorohexadecafluorooctyl methyl ether, 7-trifluorohexadecafluorooctyl ethyl ether, and 7-trifluorohexadecafluorohexyl octyl ether. Further, the iso(perfluoroalkyl)alkyl ethers and the (perfluoroalkyl)alkyl ethers having a straight chain structure described above can be used in combination.

For the electrolyte of the present invention, it is preferable to use alkali metal salts (e.g., lithium salts) such as alkali metal perchlorate, organoboron alkali metal salt, alkali metal salt of fluorine-containing compound and alkali metal imide salt. Specific examples of such electrolyte salts include MClO₄ (where M is an alkali metal element such as Li, Na, K or the like; the same is true in the following), MPF₆, MBF₄, MAsF₆, MSbF₆, MCF₃SO₃, MCF₃CO₂, M₂C₂F₄(SO₃)₂, MN(CF₃SO₂)₂, MN(C₂F₅SO₂)₂, MC(CF₃SO₂)₃, MCₙF₂ₙ₊₁SO₃ (where 2≦n≦7), and MN(RfOSO₂)₂ (where Rf is a fluoroalkyl group). Among these compounds, those with M being a lithium element are more preferable, and fluorine-containing organic lithium salt is particularly preferable. Since fluorine-containing organic lithium salt is highly anionic and causes ion separation easily, it can dissolve in the electrolyte easily.

The concentration of the electrolyte salt in the electrolyte is preferably, for example, 0.3 mol/L or more, and more preferably 0.7 mol/L or more, and preferably 1.7 mol/L or less, and more preferably 1.2 mol/L or less. If the concentration of the electrolyte salt is too small, the ion conductivity may drop. On the other hand, if the concentration of the electrolyte salt is too large, the electrolyte salt may not dissolve entirely and the undissolved electrolyte salt may be precipitated.

To the electrolyte of the present invention, a variety of additives capable of improving the performance of the electrochemical device using the electrolyte may be added.

For example, if an electrolyte containing a compound having an unsaturated carbon-carbon bond in a molecule as an additive is used for an electrochemical device, the deterioration of the charge-discharge cycle characteristics of the device may be suppressed. Examples of compounds having an unsaturated carbon-carbon bond in a molecule include: aromatic compounds such as C₆H₅C₆H₁₁ (cyclohexylbenzene); fluorinated aliphatic compounds such as H(CF₂)₄CH₂OOCCH═CH₂ and F(CF₂)₈CH₂CH₂OOCCH═CH₂; and fluorine-containing aromatic compounds. Further, it is also possible to use compounds having a sulfur element including 1,3-propane sulton and 1,2-propanediol sulfate (e.g., chain or cyclic sulfonates and sulfates) and cyclic carbonates having an unsaturated carbon-carbon bond such as vinylene carbonate, and use of these additives can be very effective in some cases. For example, the amount of any of these various additives added to the electrolyte is preferably 0.5 to 5 mass % of the total amount of the electrolyte.

In order to achieve improvements in the high-temperature characteristics of the electrochemical device, acid anhydride may be additionally added to the electrolyte of the present invention. As a negative electrode surface modifier, acid anhydride involves in the formation of a composite coating on the surface of the negative electrode, and includes the capability of further improving, for example, the storability of the electrochemical device under high temperature conditions. Further, since the addition of acid anhydride to the electrolyte leads to a reduction in the moisture content of the electrolyte, the amount of gas to be produced in the electrochemical device using the electrolyte can be further reduced. Acid anhydride to be added to the electrolyte is not particularly limited as long as a compound having at least one acid anhydride structure in a molecule is used, and the compounds may have more than one acid anhydride structure in a molecule. Specific examples of acid anhydrides include mellitic anhydride, malonic anhydride, maleic anhydride, butyric anhydride, propionic anhydride, pulvinic anhydride, phthalonic anhydride, phthalic anhydride, pyromellitic anhydride, lactic anhydride, naphthalic anhydride, toluic anhydride, thiobenzoic anhydride, diphenic anhydride, citraconic anhydride, diglycolamidic anhydride, acetic anhydride, succinic anhydride, cinnamic anhydride, glutaric anhydride, glutaconic anhydride, valeric anhydride, itaconic anhydride, isobutyric anhydride, isovaleric anhydride, and benzoic anhydride, and these acid anhydrides may be used alone or in combination of two or more.

The amount of acid anhydride added to the electrolyte of the present invention is preferably 0.05 to 2 mass % of the total amount of the electrolyte. In order to ensure that the discharge characteristics of the electrochemical device that uses the electrolyte also containing acid anhydride become favorable, the amount of acid anhydride added to the electrolyte is more preferably 1 mass % of the total amount of the electrolyte.

In particular, when the negative electrode (described later in detail) of the electrochemical device using the electrolyte of the present invention includes a carbon material as an active material, it is preferable that the electrolyte of the present invention includes any of the cyclic carbonates mentioned above, and it is more preferable that the electrolyte includes ethylene carbonate and/or vinylene carbonate. When the electrolyte includes cyclic carbonate including ethylene carbonate, the amount of the cyclic carbonate used in the electrolyte is preferably 10 mass % or more, and preferably 60 mass % or less, and more preferably 40 mass % or less of the total of solvents in the electrolyte. On the other hand, when the electrolyte includes cyclic carbonate having an unsaturated carbon-carbon bond, including vinylene carbonate, it is recommended that the amount of the cyclic carbonate in the electrolyte is set to the preferred value described above (i.e., 0.5 to 5 mass % of the total amount of the electrolyte).

In addition to being used in the form of a liquid, the electrolyte of the present invention also may be used in the form of a gel in producing the electrochemical device. A polymer may be used to gelate the electrolyte of the present invention. The following may be used to gelate the electrolyte: straight chain polymers such as polyethylene oxide and polyacrylonitril or copolymers thereof, and polymers produced by polymerizing multifunctional monomers that can be polymerized by irradiation with active rays such as ultraviolet rays and electron beams (e.g., tetra- or more functional acrylates such as pentaerythritol tetraacrylate, ditrimethylolpropane tetraacrylate, ethoxylated pentaerythritol tetraacrylate, dipentaerythritol hydroxypentaacrylate, dipentaerythritol hexaacrylate, and tetra- or more functional methacrylates similar to the acrylates mentioned).

(Electrochemical Device)

Next, the electrochemical device of the present invention will be described. In addition to a nonaqueous secondary battery using a nonaqueous electrolyte, the electrochemical device of the present invention may be a nonaqueous primary battery, a supper capacitor, or the like.

As long as the electrochemical device of the present invention includes a positive electrode, a negative electrode, a separator and the electrolyte of the present invention, its other components and structure are not particularly limited. Therefore, any of various components and structures adopted for a variety of conventionally-known electrochemical devices including a nonaqueous electrolyte (such as nonaqueous secondary batteries, nonaqueous primary batteries and super capacitors) can be applied to the electrochemical device of the present invention.

For the electrochemical device of the present invention, it is possible to use, for example, a positive electrode including a current collector and a positive electrode mixture layer made from a positive electrode mixture containing a positive electrode active material, a binder, and, as needed, a conductive assistant, and formed on one or both sides of the current collector.

Examples of the positive electrode active material include: lithium cobalt oxides such as LiCoO₂; lithium manganese oxides such as LiMnO₂, LiMn₂O₄ and Li₂MnO₃; lithium nickel oxides such as LiNiO₂; spinel-structured lithium-containing composite oxides such as LiMn₂O₄ and Li_{4/3}Ti_{5/3}O₄; olivine-structured lithium-containing composite oxides such as LiFePO₄; and oxides whose basic compositions are the same as those of the oxides mentioned but partially replaced with various elements (e.g., LiNi_{1-x-y}CoₓAl_{y}O₂ and LiNi_{0.5}Co_{0.2}Mn_{0.3}O₂). In terms of achieving a high capacity, nickel-containing lithium composite oxides having Ni as a constituent element such as LiNiO₂, LiNi_{1-x-y}CoₓAl_{y}O₂ and LiNi_{0.5}Co_{0.2}Mn_{0.3}O₂ can be used preferably. These positive electrode active materials can be used alone or in combination of two or more.

As long as being chemically stable in an electrochemical battery such as a nonaqueous secondary battery, any of thermoplastic and thermosetting resins can be used as a binder for the positive electrode. Examples of such resins include polyethylene, polypropylene, polytetrafluoroethylene (PTFE), polyvinylidene fluoride (PVDF), polyhexafluoropropylene (PHFP), styrene-butadiene rubber, tetrafluoroethylene-hexafluoroethylene copolymers, tetrafluoroethylene-hexafluoropropylene copolymers (FEP), tetrafluoroethylene-perfluoroalkyl vinyl ether copolymers (PFA), vinylidene fluoride-hexafluoropropylene copolymers, vinylidene fluoride-chlorotrifluoroethylene copolymers, ethylene-tetrafluoroethylene copolymers (ETFE resin), polychlorotrifluoroethylene (PCTFE), vinylidene fluoride-pentafluoropropylene copolymers, propylene-tetrafluoroethylene copolymers, ethylene-chlorotrifluoroethylene copolymers (ECTFE), vinylidene fluoride-hexafluoropropylene-tetrafluoroethylene copolymers, vinylidene fluoride-perfluoromethylvinyl ether-tetrafluoroethylene copolymers, and ethylene-acrylic acid copolymers, ethylene-methacrylic acid copolymers, ethylene-methyl acrylate copolymers, ethylene-methyl methacrylate copolymers, and Na ion crosslinked copolymers thereof. These materials may be used alone or in combination of two or more. Among these materials, it is preferable to use fluororesins such as PVDF, PTFE and PHFP in view of their stability in the electrochemical device as well as the characteristics of the electrochemical device. They may be used in combination or in the form of a copolymer by polymerizing these resin monomers.

As long as the binder can bond the positive electrode active material and the conductive assistant stably, its amount in the positive electrode mixture layer of the positive electrode is preferably as small as possible. For example, the amount of the binder in the positive electrode mixture layer is preferably 0.03 to 2 parts by mass with respect to 100 parts by mass of the positive electrode active material.

As long as being chemically stable in an electrochemical device such as a nonaqueous secondary battery, any conductive assistant can be used in the positive electrode. Examples of conductive assistants include: graphites such as natural graphite and artificial graphite; carbon blacks such as acetylene black, Ketjen Black (trade name), channel black, furnace black, lamp black and thermal black; conductive fibers such as carbon fibers and metal fibers; metal powders such as an aluminum powder; carbon fluoride; zinc oxide; conductive whiskers made of potassium titanate and the like; conductive metal oxides such as titanium oxide; and organic conductive materials such as polyphenylene derivatives. These materials may be used alone or in combination of two or more. Among these conductive assistants, it is preferable to use graphite and carbon black because graphite is highly conductive and carbon black has excellent liquid absorbency. Further, the conductive assistant does not need to be in the form of primary particles, and it is also possible to use the conductive assistant in the form of secondary aggregates or clusters such as chain structures. Since such clusters are easy to handle, the productivity can be improved.

As long as excellent conductivity and liquid absorbency can be ensured, the amount of the conductive assistant in the positive electrode mixture layer of the positive electrode is not limited but is preferably 0.1 to 2 parts by mass with respect to 100 parts by mass of the positive electrode active material.

For example, the positive electrode can be produced through the steps of dispersing a positive electrode active material, a binder and a conductive assistant in a solvent to prepare a positive electrode mixture-containing composition in the form of a paste or slurry (the binder may be dissolved in the solvent), applying the positive electrode mixture-containing composition to one or both sides of a current collector, drying the applied composition, and, as needed, further subjecting the current collector to pressing so as to adjust the thickness and the density of the positive electrode mixture layer. The method for producing the positive electrode is not limited to the method mentioned above, and other methods may be used to produce the positive electrode.

The material of the current collector of the positive electrode is not particularly limited as long as an electron conductor that is chemically stable in an electrochemical device such as a nonaqueous secondary battery is used. For example, in addition to aluminum or aluminum alloys, stainless steel, nickel, titanium, carbon, and conductive resins, composite materials having a carbon layer or titanium layer on the surface of aluminum, aluminum alloy or stainless steel can be used. Among these materials, aluminum and aluminum alloys are particularly preferable because they are light-weight and highly electron conductive. For the current collector of the positive electrode, for example, a foil, a film, a sheet, a net, a punched sheet, a lath, a porous sheet, a foam or a molded article of fiber bundle made of any of the materials mentioned above is used. Further, the current collector can be subjected to a surface treatment to roughen the surface. The thickness of the current collector is not particularly limited but is normally 1 to 500 μm.

To apply the positive electrode mixture-containing composition onto the surface of such a current collector, the substrate withdrawing method using a doctor blade, the coater method using a die coater, a comma coater, a knife coater or the like, or the printing method such as screen printing, relief printing or the like can be adopted, for example.

The positive electrode mixture layer of the positive electrode formed in the above manner preferably has a thickness of 15 to 200 μm per one side of the current collector. Further, the density of the positive electrode mixture layer is preferably 3.2 g/cm³ or more, and more preferably 3.4 g/cm³ or more. Use of the positive electrode having such a high density positive electrode mixture layer leads to the electrochemical device with a higher capacity. However, if the density of the positive electrode mixture layer is too high, the porosity declines and the penetration of the electrolyte may drop. Therefore, the density of the positive electrode mixture layer is preferably 3.8 g/cm³ or less. After being formed, the positive electrode mixture layer may be pressed, for example, roll-pressed at a line pressure of about 1 to 100 kN/cm to achieve the above density.

Here, the density of the positive electrode mixture layer is a value measured by the following method. First, the positive electrode is cut into a piece having a certain area, the mass of the piece is measured with an electrobalance with a minimum scale value of 0.1 mg, and the mass of the positive electrode mixture layer is calculated by subtracting the mass of the current collector from the mass of the positive electrode piece. Meanwhile, the total thickness of the positive electrode is measured at ten points using a micrometer with a minimum scale value of 1 μm, and the volume of the positive electrode mixture layer is calculated from the area and the average of values obtained by subtracting the current collector thickness from these measured values. Then, the density of the positive electrode mixture layer is calculated by dividing the mass of the positive electrode mixture layer by the volume.

For the electrochemical device of the present invention, it is possible to use a negative electrode including a current collector and a negative electrode mixture layer made from a negative electrode mixture containing a negative electrode active material, a binder, and, as needed, a conductive assistant and formed on one or both sides of the current collector.

Examples of the negative electrode active material include: carbon materials such as graphite, pyrolytic carbons, cokes, glassy carbons, baked organic polymer compounds, mesocarbon microbeads, carbon fibers, and activated carbons; and simple substances of elements capable of being alloyed with lithium, such as silicon (Si) and tin (Sn), or compounds of such elements.

Examples of the compounds of elements capable of being alloyed with lithium include oxides of elements capable of being alloyed with lithium (e.g., SiO, SnO, and Si₁₋ₓSnₓO) and alloys of elements capable of being alloyed with lithium and those not capable of being alloyed with lithium (e.g., SiCo and SnCo alloys).

When using a high-capacity active material such as nickel-containing lithium composite oxide in the positive electrode described above, it is necessary to increase the capacity of the negative electrode accordingly. Thus, in terms of increasing the capacity of the negative electrode, it is preferable to use, as the negative electrode active material, a simple substance of an element capable of being alloyed with lithium or a compound of the element, and it is more preferable to use it together with a carbon material such as graphite.

As an oxide of an element capable of being alloyed with lithium, for example, a material represented by the general formula SiO and including Si and oxygen (O) as constituent elements can be used suitably (where x is the atomic ratio of O to Si in the material as a whole), and one with x being in a range of 0.5 to 1.5 can be used preferably. The material does not need to be composed only of a single oxide phase and may include Si microcrystal or an Si amorphous phase. In this case, the atomic ratio is a ratio of O to Si including Si in the microcrystal or in the amorphous phase. That is, examples of SiOₓ include one having a structure in which Si (e.g., microcrystalline Si) is dispersed in an amorphous SiO₂ matrix, and one with the atomic ratio x (together with the amorphous SiO₂ and the Si dispersed in the amorphous SiO₂ as a whole) satisfying 0.5≦x≦1.5 can be used preferably.

Further, it is desirable that a simple substance of an element capable of being alloyed with lithium, or a compound of the element is in the form of a composite with a carbon material, for example, it is desirable that the simple substance or the compound is coated with a carbon material and forms a composite with the carbon material. An oxide material such as Si0 particularly has poor conductivity. Thus, when using it as a negative electrode active material, it is necessary to form an excellent conductive network, in view of ensuring good battery characteristics, by using a conductive material (conductive assistant) and allowing the negative electrode active material and the conductive material to be mixed and dispersed favorably in the negative electrode. Use of a composite of a negative electrode active material and a conductive material leads to the formation of a better conductive network in the negative electrode than using a material obtained by simply mixing a negative electrode active material and a conductive material such as a carbon material.

Preferred examples of carbon materials that can be used to form a composite with the negative electrode active material include carbon blacks (including acethylene black and Ketjen Black), low crystalline carbons, artificial graphite, easily graphitizable carbon, hardly graphitizable carbon, carbon nanotubes, and vapor grown carbon fibers.

The carbon material is preferably in the form of a fiber or coil because a conductive network can be formed with ease and it has a large surface area.

Further, it is preferable that the carbon material includes carbon black, easily graphitizable carbon and hardly graphitizable carbon because they have high electric conductivity and liquid retentivity, and further they have the property of easily maintaining contact with the particles of the negative electrode active material even if the particles shrink or swell.

When using, as the negative electrode active material, a material highly reactive with a nonaqueous electrolyte solvent, such as a simple substance of an element capable of being alloyed with lithium or a compound of the element, it is necessary to suppress reactions between the negative electrode active material and the electrolyte. Thus, in this case, it is preferable to include fluorinated cyclic carbonate, in particular, fluoroethylene carbonate in the nonaqueous electrolyte. As described above, it is believed that fluorinated cyclic carbonates such as fluoroethylene carbonate can suppress reactions between the negative electrode mixture layer (negative electrode active material) and the electrolyte by forming a coating on the surface of the negative electrode (the surface of the negative electrode mixture layer).

Further, when using any of the carbon materials described above as the negative electrode active material in the electrochemical device of the present invention, it is preferable that the electrolyte contains vinylene carbonate. In this case, a coating derived from vinylene carbonate is formed on the surface of the negative electrode (the surface of the negative electrode mixture layer) in the electrochemical device, so that reactions between the negative electrode mixture layer (negative electrode active material) and the electrolyte can be suppressed favorably.

Normally, vinylene carbonate is decomposed at the positive electrode in the electrochemical device and causes swelling of the electrochemical device. However, since the electrochemical device of the present invention uses the electrolyte of the present invention that includes the imide compound represented by the general formula (1) and/or the imide compound represented by the general formula (2), it is also possible to suppress, by the action of these imide compounds, swelling of the electrochemical device resulting from the decomposition of vinylene carbonate at the positive electrode. Consequently, it is possible to exploit the functions of vinylene carbonate effectively while suppressing the problems associated with the use of vinylene carbonate.

The binders and the conductive assistants described above as being usable for the positive electrode can also be used for the negative electrode.

The material of the current collector of the negative electrode is not particularly limited as long as an electron conductor that is chemically stable in the formed battery is used. For example, in addition to copper or copper alloys, stainless steel, nickel, titanium, carbon, conductive resins, and composite materials having a carbon layer or titanium layer on the surface of copper, copper alloy or stainless steel can be used. Among these materials, copper and copper alloys are particularly preferable because they do not alloy with lithium and are highly electron conductive. For the current collector of the negative electrode, for example, a foil, a film, a sheet, a net, a punched sheet, a lath, a porous sheet, a foam or a molded article of fiber bundle made of any of the materials mentioned above can be used. Further, the current collector can be subjected to a surface treatment to roughen the surface. The thickness of the current collector is not particularly limited but is normally 1 to 500 μm.

For example, the negative electrode can be produced through the steps of dispersing a negative electrode mixture containing a negative electrode active material, a binder, and, as needed, a conductive assistant in a solvent to prepare a negative electrode mixture-containing composition in the form of a paste or slurry (the binder may be dissolved in the solvent), applying the negative electrode mixture-containing composition to one or both sides of a current collector, drying the applied composition to form a negative electrode mixture layer. The method for producing the negative electrode is not limited to the method mentioned above, and other methods may be used to produce the negative electrode.

The thickness of the negative electrode mixture layer is preferably 10 to 300 μm per one side of the current collector. Further, as for the composition of the negative electrode mixture layer, the amount of the negative electrode active material is preferably 90 to 99 mass %, and the amount of the binder is preferably 1 to 10 mass %. When a conductive assistant is further used in the negative electrode, the amount of the conductive assistant is preferably 0.5 to 5 mass %.

The separator of the electrochemical device is preferably a porous film made of any of the following: polyolefins such as polyethylene, polypropylene, and ethylene-propylene copolymers; and polyesters such as polyethylene terephthalate and copolymerized polyester. The separator preferably has the property of closing its pores at 100 to 140° C. (i.e., the shutdown function). Therefore, it is more preferable that the separator includes, as a component, a thermoplastic resin whose melting point, i.e., melting temperature measured in accordance with the Japanese Industrial Standards (JIS) K 7121 with a differential scanning calorimeter (DSC) is 100 to 140° C., and it is preferable that the separator is a single-layer porous film predominantly composed of polyethylene or a laminated porous film in which two to five polyethylene and polypropylene layers are laminated. When using a laminated porous film including a polyethylene layer and a layer composed of a resin having a higher melting point than that of polyethylene, such as polypropylene, polyethylene makes up desirably 30 mass % or more, and more desirably 50 mass % or more of all of the resins of the porous film.

As such a resin porous film, it is possible to use porous films made of the thermoplastic resins described above that are used in conventionally-known electrochemical devices such as nonaqueous secondary batteries, i.e., it is possible to use ion permeable porous films (microporous films) produced by solvent extraction, dry or wet drawing or the like.

The average pore size of the separator is preferably 0.01 μm or more, and more preferably 0.05 μm or more, and preferably 1 μm or less, and more preferably 0.5 μm or less.

As for the air permeability of the separator, it is desirable that the separator has a Gurley value of 10 to 500 sec. The Gurley value is obtained in accordance with JIS P 8117 and expressed as the length of time (seconds) it takes for 100 mL air to pass through the membrane at a pressure of 0.879 g/mm². If the air permeability is too large, the ion permeability may decline. On the other hand, if the air permeability is too small, the strength of the separator may decline. Furthermore, it is desirable that the separator has strength of 50 g or more, the strength being a piercing strength obtained using a needle having a diameter of 1 mm. When the piercing strength is too small, the following problem may arise. That is, when lithium dendrites develop, the lithium dendrites may penetrate through the separator and cause a short circuit.

The electrochemical device of the present invention is formed by laminating the positive electrode and the negative electrode described above through the separator to produce a laminated electrode body or further winding the laminated electrode body in a spiral fashion to produce a wound electrode body, placing such an electrode body and the electrolyte of the present invention in an outer package in the usual manner, and sealing the outer package. As with conventionally-known electrochemical devices such as nonaqueous secondary batteries, the form of the electrochemical device of the present invention may be cylindrical using a cylindrical (e.g., circular cylindrical or rectangular cylindrical) outer can or flat using a flat (circularly or rectangularly flat in plan view) outer can or the electrochemical device may be of a soft package type using a metal-evaporated laminated film as an outer case member. As the outer can, those made of steel and aluminum can be used.

Hereinafter, a nonaqueous secondary battery as a typical example of the electrochemical device of the present invention will be described with reference to the drawings.

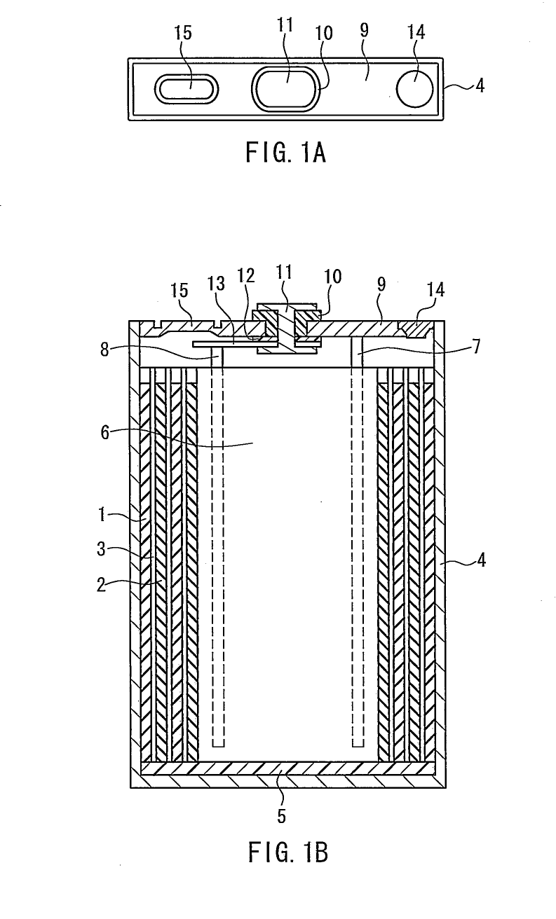

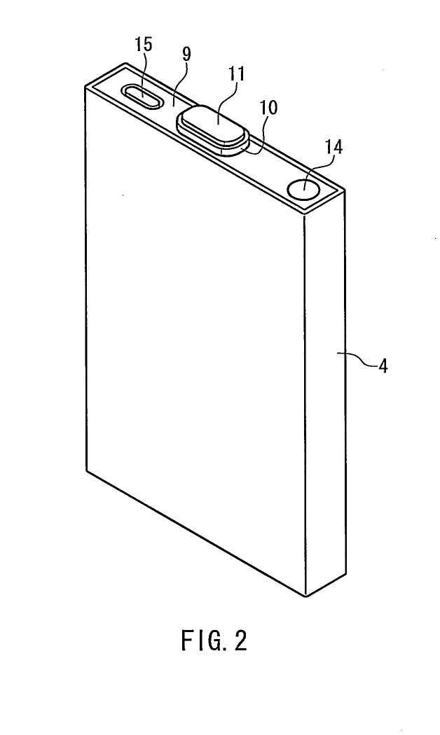

FIG. 1A is a plan view showing an exemplary nonaqueous secondary battery according to the present invention, and FIG. 1B is a cross-sectional view of the battery shown in FIG. 1A. Further, FIG. 2 is a perspective view of the nonaqueous secondary battery shown in FIGS. 1A and 1B.

As shown in FIG. 1B, a positive electrode 1 and a negative electrode 2 are wound in a spiral fashion through a separator 3, and then they are pressed into a flat shape, thereby forming a flat wound electrode body 6. The wound electrode body 6, together with a nonaqueous electrolyte, is housed in a rectangular cylindrical outer can 4. For the sake of simplicity, FIG. 1B does not illustrate metal foils used as current collectors in producing the positive electrode 1 and the negative electrode 2, a nonaqueous electrolyte, and the like. Also, hatching lines indicating a cross section are not given to the internal part of the wound electrode body 6.

The outer can 4 is made of aluminum alloy, and serves as the outer package of the battery. The outer can 4 also serves as a positive electrode terminal. An insulator 5 made of a PE sheet is placed at the bottom of the outer can 4. A positive electrode lead 7 connected to one end of the positive electrode 1 and a negative electrode lead 8 connected to one end of the negative electrode 2 are drawn from the wound electrode body 6 composed of the positive electrode 1, the negative electrode 2, and the separator 3. A stainless steel terminal 11 is attached to a cover plate 9 via a PP insulating packing 10. The cover plate 9 is made of aluminum alloy and used to seal the opening of the outer can 4. A stainless steel lead plate 13 is attached to the terminal 11 via an insulator 12.

The cover plate 9 is inserted into the opening of the outer can 4, and the joint therebetween is welded to seal the opening of the outer can 4, so that the inside of the battery is hermetically sealed. Moreover, in the battery shown in FIGS. 1A and 1B, the cover plate 9 is provided with an inlet 14 through which the nonaqueous electrolyte is injected. The inlet 14 is sealed with a sealing member by, for example, laser welding, thereby ensuring the closeness of the battery. In the battery shown in FIGS. 1A, 1B, and 2, the inlet 14 is actually composed of the inlet and a sealing member but only the inlet 14 is shown for the sake of simplicity. Further, the cover plate 9 is provide with a cleavable vent 15 as a mechanism for discharging gas in the battery to the outside when the temperature of the battery is elevated.

In the above battery, the positive electrode lead 7 is directly welded to the cover plate 9, so that the outer can 4 and the cover plate 9 function as positive electrode terminals. Further, the negative electrode lead 8 is welded to the lead plate 13, and thus electrically connected to the terminal 11 via the lead plate 13, so that the terminal 11 functions as a negative electrode terminal. However, the positive and the negative may be reversed depending on, for example, the material of the outer can 4.

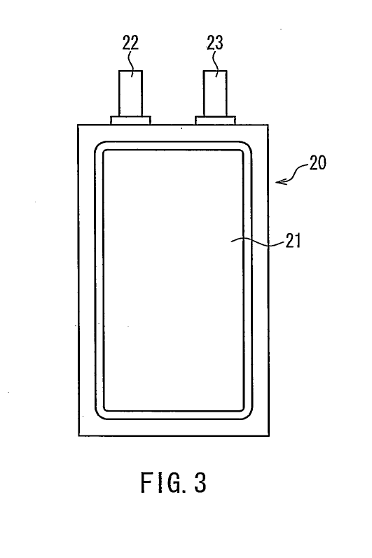

FIG. 3 is a plan view showing other exemplary nonaqueous secondary battery according to the present invention. In the nonaqueous secondary battery 20 according to the present invention shown in FIG. 3, a positive electrode, a negative electrode, and a nonaqueous electrolyte are housed in an outer package 21 made of an aluminum laminated film and having a rectangular shape in plan view. And a positive electrode external terminal 22 and a negative electrode external terminal 23 are drawn from the same side of the outer package 21.

The electrochemical device of the present invention can be used in applications including power sources for various electronic devices such as portable electronic devices including portable phones, notebook personal computers, and the like, and can be also used in applications where safety is valued, such as electric tools, automobiles, bicycles and power storages.

Hereinafter, the present invention will be described in detail by way of Examples. Note that the present invention is not limited to the following Examples.

### EXAMPLE 1

<Production of Positive Electrode>

100 parts by mass of positive electrode active material represented by Li_{1.02}Ni_{0.82}Co_{0.15}Al_{0.03}O₂, 20 parts by mass of NMP solution containing PVDF as a binder at a concentration of 10 mass %, 1 part by mass of artificial graphite and 1 part by mass of Ketjen Black as conductive assistants were mixed using a planetary mixer. NMP was further added to the mixture to adjust the viscosity, thus preparing a positive electrode mixture-containing paste.

Next, the positive electrode mixture-containing paste was applied to both sides of a 15 μm-thick aluminum foil (positive electrode current collector), followed by drying in a vacuum for 12 hours at 120° C., thus forming positive electrode mixture layers on both sides of the aluminum foil. Subsequently, the aluminum foil was subjected to pressing to adjust the thickness and the density of the positive electrode mixture layers, and a nickel lead was welded to an exposed part of the aluminum foil, thus producing a strip-shaped positive electrode having 375 mm in length and 43 mm in width. Each of the positive electrode mixture layers of the obtained positive electrode had a thickness of 55 μm.

<Production of Negative Electrode>

SiO particles having a number-average particle size of 5.0 μm were heated to about 1,000° C. in an ebullated bed reactor, and then the heated particles were brought into contact with 25° C. mixed gas of methane and nitrogen gas to carry out chemical vapor deposition (CVD) for 60 minutes at 1,000° C. Carbon produced by the thermal decomposition of the mixed gas (hereinafter also referred to as “CVD carbon”) in this way was deposited on the surface of the SiO particles to form a coating layer, thus obtaining carbon-coated SiO.

The composition ratio of the carbon-coated SiO was calculated from changes in the mass before and after the formation of the coating layer, and it was found that the ratio of SiO to CVD carbon was 85:15 (mass ratio).

Next, 95 parts by mass of natural graphite having a number-average particle size of 10 μm was mixed with 5 parts by mass of the carbon-coated SiO to produce a mixture of the negative electrode active materials Further, 97.5 parts by mass of the mixture, 1.5 parts by mass of styrene-butadiene rubber as a binder, 1 part by mass of carboxymethyl cellulose as a thickener, and water were mixed, thus preparing a negative electrode mixture-containing paste. The negative electrode mixture-containing paste was applied to both sides of a 8 μm-thick copper foil, followed by drying in a vacuum for 12 hours at 120° C., thus forming negative electrode mixture layers on both sides of the copper foil. Subsequently, the copper foil was subjected to pressing to adjust the thickness and the density of the negative electrode mixture layers, and a nickel lead was welded to an exposed part of the copper foil, thus producing a strip-shaped negative electrode having 380 mm in length and 44 mm in width. Each of the negative electrode mixture layers of the obtained negative electrode had a thickness of 65 μm.

<Preparation of Nonaqueous Electrolyte>

LiPF₆ was dissolved at a concentration of 1 mol/L in a mixed solvent of ethylene carbonate, methyl ethyl carbonate, and diethyl carbonate at a volume ratio of 2:3:1. Further, to this mixed solvent, 0.5 mass % of imide compound represented by the following formula (3), 2.5 mass % of vinylene carbonate (VC), and 1.0 mass % of fluoroethylene carbonate (FEC) were added, thus preparing a nonaqueous electrolyte.

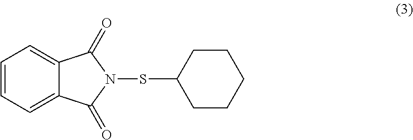 [SMILES: O=C1c2ccccc2C(=O)N1SC1CCCCC1]

The imide compound represented by the formula (3) was the imide compound represented by the general formula (2), where R² was a cyclohexyl group.

<Assembly of Battery>

The strip-shaped positive electrode was stacked on top of the strip-shaped negative electrode through a 16 μm-thick microporous polyethylene separator (porosity: 41%), and they were wound in a spiral fashion. Subsequently, they were pressed into a flat shape, thus obtaining a flat wound electrode body. The wound electrode body was fixed with a polypropylene insulating tape. Next, the wound electrode body was inserted in a rectangular battery case made of aluminum alloy and having outer dimensions of 4.0 mm (thickness)×34 mm (width)×50 mm (height), a lead was welded to the battery case, and an aluminum alloy cover plate was welded to an opening end of the battery case. Thereafter, the nonaqueous electrolyte was injected through the inlet of the cover and was allowed to stand for 1 hour. Then, the inlet was sealed, and a nonaqueous secondary battery having the structure as shown in FIGS. 1A and 1B and the appearance as shown in FIG. 2 was obtained. The design electric capacity of the nonaqueous secondary battery was about 840 mAh.

### EXAMPLE 2

A positive electrode was produced in the same manner as in Example 1 except that Li_{1.02}Ni_{0.6}Mn_{0.2}Co_{0.2}O₂ was used as the positive electrode active material.

Further, a nonaqueous electrolyte was prepared in the same manner as in Example 1 except that 0.8 mass % of imide compound represented by the following formula (4) was added in place of the imide compound represented by the formula (3).

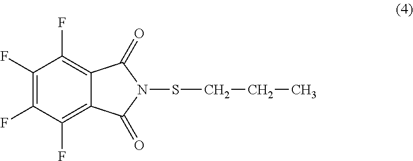 [SMILES: CCCSN1C(=O)c2c(F)c(F)c(F)c(F)c2C1=O]

The imide compound represented by the formula (4) was the imide compound represented by the general formula (2), where R² was a propyl group and H of the benzene ring was entirely replaced with F.

Except using the positive electrode and the nonaqueous electrolyte obtained above, a nonaqueous secondary battery was produced in the same manner as in Example 1.

### EXAMPLE 3

A positive electrode was produced in the same manner as in Example 1 except that a mixed active material of LiCoO₂ and Li_{1.02}Ni_{0.9}Co_{0.05}Mn_{0.025}Mg_{0.025}O₂ at a mass ratio of 7:3 was used as the positive electrode active material.

Further, a nonaqueous electrolyte was prepared in the same manner as in Example 1 except that 0.5 mass % of imide compound represented by the following formula (5) was added in place of the imide compound represented by the formula (3).

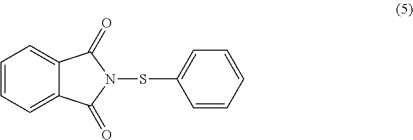 [SMILES: O=C1c2ccccc2C(=O)N1Sc1ccccc1]

The imide compound represented by the formula (5) was the imide compound represented by the general formula (2), where R² was a phenyl group.

Except using the positive electrode and the nonaqueous electrolyte obtained above, a nonaqueous secondary battery was produced in the same manner as in Example 1.

### EXAMPLE 4

A positive electrode was produced in the same manner as in Example 1 except that Li_{1.02}Ni_{0.6}Mn_{0.2}Co_{0.2}O₂ was used as the positive electrode active material.

A negative electrode was produced in the same manner as in Example 1 except that natural graphite having a number-average particle size of 10 μm was used as the only negative electrode active material in place of the mixture.

Further, a nonaqueous electrolyte was prepared in the same manner as in Example 1 except that fluoroethylene carbonate was not added.

Except using the positive electrode, the negative electrode and the nonaqueous electrolyte obtained above, a nonaqueous secondary battery was produced in the same manner as in Example 1.

### COMPARATIVE EXAMPLE 1

A nonaqueous electrolyte was prepared in the same manner as in Example 1 except that the imide compound represented by the formula (3) was not added. Except using this nonaqueous electrolyte, a nonaqueous secondary battery was produced in the same manner as in Example 1.

### COMPARATIVE EXAMPLE 2

A nonaqueous electrolyte was prepared in the same manner as in Example 2 except that the imide compound represented by the formula (4) was not added. Except using this nonaqueous electrolyte, a nonaqueous secondary battery was produced in the same manner as in Example 2.

Each of the following evaluations was performed on the nonaqueous secondary batteries of Examples 1 to 4 and Comparative Examples 1 to 2. Table 1 provides the results.

<Measurement of Discharge Capacity>

Each of the batteries of Examples 1 to 4 and Comparative Examples 1 to 2 was stored for 7 hours at 60° C. Subsequently, at 20° C., each of the batteries was charged at a current of 200 mA for 5 hours, and then discharged at a current of 200 mA until the battery voltage dropped to 3 V, and the charging and the discharging were repeated in cycles until the discharged capacity became constant. Next, each of the batteries was charged at a constant current and a constant voltage (constant current: 500 mA, constant voltage: 4.2 V, and total charging time: 3 hours), and then brought to a standstill for 1 hour. Subsequently, each of the batteries was discharged at a current of 200 mA until the battery voltage became 3 V, and the standard capacity of each of the batteries was determined. In calculating the standard capacity, 100 batteries for each Example were measured, and the average of the measured values was taken as the standard capacity of the battery of each of Examples and Comparative Examples.

<High-Temperature Storability>

Each of the batteries of Examples 1 to 4 and Comparative Examples 1 to 2 was charged at a constant current and a constant voltage (constant current: 0.4 C, constant voltage: 4.25 V, and total charging time: 3 hours). Subsequently, each of the batteries was placed in a thermostatic oven and left there for 5 days at 80° C., and then the thickness of each of the batteries was measured. On the basis of battery swelling during the storage determined from the difference between the thickness of each battery before (4.0 mm) and after the storage, the high-temperature storability was evaluated.

TABLE 1

| | Additives to nonaqueous electrolyte | | | | |
|---|---|---|---|---|---|
| | Amount | | | | |
| | of imide | | | | |
| | compound | Amount of | Amount of | Standard | Battery |
| | added | VC added | FEC added | capacity | swelling |
| | (mass %) | (mass %) | (mass %) | (mAh) | (mm) |
| Ex. 1 | 0.5 | 2.5 | 1.0 | 841 | 1.02 |
| Ex. 2 | 0.8 | 2.5 | 1.0 | 837 | 0.97 |
| Ex. 3 | 0.5 | 2.5 | 1.0 | 835 | 0.85 |
| Ex. 4 | 0.5 | 2.5 | 0 | 804 | 0.73 |
| Comp. Ex. 1 | 0 | 2.5 | 1.0 | 835 | 1.65 |
| Comp. Ex. 2 | 0 | 2.5 | 1.0 | 836 | 1.44 |

In Table 1, “Amount of imide compound added” refers to the amount of the imide compound represented by the formula (3), the imide compound represented by the formula (4), or the imide compound represented by the formula (5) added. Further, “Amount of VC added” refers to the amount of vinylene carbonate added, and “Amount of FEC added” refers the amount of fluoroethylene carbonate added.

As can be seen from Table 1, the nonaqueous secondary batteries of Examples 1 to 4 that used the electrolytes containing the imide compound represented by the general formula (1) or the imide compound represented by the general compound (2) as an additive swelled less during the high-temperature storage than the batteries of Comparative Examples 1 and 2 that used the electrolytes containing none of the imide compounds, and thus the batteries of Examples 1 to 4 had high-temperature storability superior to those of the batteries of Comparative Examples 1 and 2.

Further, for the battery of Example 4, its swelling during the high-temperature storage was small and had good high-temperature storability even though it did not contain fluorinated cyclic carbonate as an additive. However, since natural graphite was used as the only negative electrode active material and a simple substance of an element capable of being alloyed with lithium or a compound of the element was not included, its negative electrode did not have a high capacity. Thus, the standard capacity of the battery of Example 4 was smaller than those of the batteries of Examples 1 to 3.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A nonaqueous electrolyte for an electrochemical device, comprising at least one selected from an imide compound represented by the general formula (1) and an imide compound represented by the general formula (2): 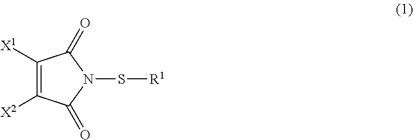
where R¹ is an organic residue or an F-containing organic residue, X¹ and X² are each H, F, an organic residue or an F-containing organic residue, and X¹ and X² may be the same or different from each other; and 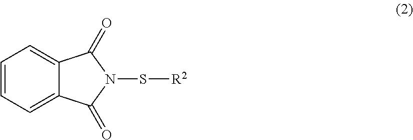
where R² is an organic residue or an F-containing organic residue, and H of a benzene ring may be partially or entirely replaced with F.

2. The nonaqueous electrolyte according to claim 1, wherein a total content of the imide compound represented by the general formula (1) and the imide compound represented by the general formula (2) is 0.05 mass % or more and 3 mass % or less of a total amount of the electrolyte.

3. The nonaqueous electrolyte according to claim 1, further comprising fluorinated cyclic carbonate.

4. The nonaqueous electrolyte according to claim 3, wherein the fluorinated cyclic carbonate is fluoroethylene carbonate.

5. The nonaqueous electrolyte according to claim 3, wherein a content of the fluorinated cyclic carbonate is 0.1 mass % or more and 5 mass % or less of a total amount of the electrolyte.

6. The nonaqueous electrolyte according to claim 1, further comprising vinylene carbonate.

7. The nonaqueous electrolyte according to claim 6, wherein a content of the vinylene carbonate is 0.5 mass % or more and 5 mass % or less of a total amount of the electrolyte.

8. An electrochemical device comprising a positive electrode, a negative electrode, a separator, and a nonaqueous electrolyte,
wherein the nonaqueous electrolyte according to claim 1 is used as the nonaqueous electrolyte.

9. The electrochemical device according to claim 8, wherein the negative electrode comprises, as a negative electrode active material, a simple substance of an element capable of being alloyed with lithium or a compound of the element.

10. The electrochemical device according to claim 8, wherein the negative electrode comprises a carbon material as a negative electrode active material.

11. The electrochemical device according to claim 8, wherein the positive electrode comprises a nickel-containing lithium composite oxide as a positive electrode active material.
